(19) United States
(12) Patent Application Publication
(10) Pub. No.: US 2003/0231131 A1
(43) Pub. Date: Dec. 18, 2003

(54) Remote control apparatus and method

(76) Inventors: Steven J. Dimig, Plymouth, WI (US); Nicholas A. Bednarek, Plainfield, IN (US); David R. Cotey, Franklin, WI (US); Christy L. Matuszewski, Oak Creek, WI (US)

Correspondence Address: Gerald L. Fellows, Esq., Michael Best & Friedrich LLP, 100 East Wisconsin Avenue, Milwaukee, WI, 53202-4108, US

(21) Appl. No.: 10/170,264

(22) Filed: Jun. 12, 2002

(51) Int. Cl. G06F 7/04; G08C 19/12; H04L 17/02

(52) U.S. Cl. 341/176; 340/825.69; 340/825.72; 340/5.72

(57) ABSTRACT

A remote control mechanism for remotely controlling an apparatus includes components having locations on the apparatus, and devices that are associated with the components and operable to change the configuration of the components. The control mechanism includes a housing that is shaped to resemble the apparatus and various switches that are coupled to the housing. The switches are operable to control the devices and at least some of the switches are located on the housing at positions that correspond to the locations of the components on the apparatus.

### FIELD OF THE INVENTION

The invention relates to controls, and more particularly to remote controls and remote control methods.

### BACKGROUND

A number of different devices and methods exist for remotely controlling functions on various types of apparatus including televisions, VCRs, stereo equipment, lighting equipment, all types of doors and windows, and the like. For example, devices and methods exist for remotely controlling functions on wheeled vehicles, such as cars, vans, minivans, sport utility vehicles, trucks, semi tractor-trailers, busses and the like, other vehicles such as boats and aircraft, and many other devices that may or may not be configured or intended to carry one or more passengers.

Conventional remote control devices used in many applications can be found in a wide variety of shapes and sizes. Regardless of the application however, a number of problems and limitations are shared by several types of remote control devices. Accordingly, the following discussion is presented by way of example only with regard to remote control devices for controlling apparatus on wheeled vehicles. The following discussion is therefore applicable to any other remote control device, including remote control devices for audio or video equipment, appliances and other home and office electronics, lights, fans, HVAC equipment, and the like.

With respect to wheeled vehicles, an example of a remote control device is the remote key fob, although such key fobs can also be provided for boats, aircraft, and other apparatus. The remote key fob is typically hand held and in some embodiments is configured for convenient attachment to a key ring. The fob can include various buttons that control functions of the vehicle, such as locking and unlocking functions of vehicle doors.

Key fobs such as those described above often include multiple user-manipulatable buttons for controlling the various vehicle functions. For example, one button can be provided on the fob for locking the vehicle doors, and another button may be provided for unlocking the vehicle doors. Typically, these buttons are labeled, include icons, or are otherwise provided with indicators to show their respective purposes. Oftentimes, the buttons are uniformly positioned in an arrangement on the fob providing a desired look and feel to the key fob.

A major advantage of key fobs over conventional keys relates to their ability to unlock vehicle doors, open vehicle doors, turn a vehicle alarm system on and off, turn vehicle lights on or off, start and/or stop the engine of the vehicle, or perform other functions before reaching the vehicle. This is especially convenient when a vehicle operator desires to perform functions of the vehicle from a distance or without having to manually perform such functions. For example, a vehicle locking or unlocking function performed by a fob can be useful when a user is carrying large or bulky items or is otherwise unable to easily manually lock or unlock the vehicle. In this respect, it can sometimes be difficult for the operator to even see the fob he or she is operating. In such cases, the operator may have to rely upon tactile sensing of the various buttons that control the vehicle operations. Uniformly positioned buttons and smoothly contoured fobs are somewhat detrimental to a user's ability to tactilely locate an appropriate button for a desired function, and can require some trial and error before the correct operation is performed.

Remote key fobs such as those described above are also becoming more and more common. When such fobs were first introduced, they carried with them a certain exclusivity and sense of novelty. As the cost of these fobs continues to decrease and as more auto makers provide remote key fobs with more cars, the level of exclusivity and novelty of such fobs has gradually decreased.

In light of the problems and limitations of the prior art described above, a need exists for remote control devices that are relatively simple in construction, inexpensive, and provide buttons or other user-manipulatable controls performing functions that are intuitive for a user based upon the locations of the buttons. Each embodiment of the present invention achieves one or more of these results.

### SUMMARY

The present invention provides a controller for controlling at least one device located in or on an apparatus. The controller includes a housing that has a shape resembling the apparatus and a switch, operable to activate the device and coupled to the housing. The switch is located on the housing in a position that corresponds to the location of the device on the apparatus. As used herein and in the appended claims, the term “on” (with respect to a device “on” an apparatus or a switch “on” a remote control device) is understood to encompass relationships between elements in which an element is located entirely inside or outside of another element as well as relationships between elements in which an element located only partially inside or outside of another element. The term “on” does not indicate or imply a particular location, orientation, or positional relationship of one element with respect to another other than the fact that one element is part of, connected to, or mechanically associated with another element or structure.

The present invention provides a remote control mechanism for remotely controlling an apparatus. The apparatus includes components having locations on the apparatus, and devices that are associated with the components and operable to change the configuration of the components. The control mechanism can include a housing that is shaped to resemble the apparatus and various switches that are coupled to the housing. The switches are operable to control devices on the apparatus, and are located on the housing in positions that correspond to locations of the corresponding devices on the apparatus.

An example of a remote control according to the present invention is a fob for operating a plurality of mechanisms occupying an area of a vehicle. The fob includes a body shaped to approximate the vehicle shape and a plurality of switches coupled to the housing. The switches are operable to operate the mechanisms of the vehicle, and at least some of the switches are positioned on the body at locations that correspond to the areas occupied by the mechanisms of the vehicle.

The present invention also provides a method for remotely changing the configuration of a component on an apparatus. For example, in embodiments of the present invention in which the present invention is employed to remotely control a component of a vehicle, the component can be a door lock or other device on the vehicle. In such cases, the method can include providing a remote controller that has a contour resembling the vehicle shape. A switch can be positioned on the controller in a position that corresponds to the location of the component on the vehicle and is remotely coupled to the component for operative communication therewith. Operation of the switch changes the configuration of the component.

The present invention also provides a remote controller for controlling devices on an apparatus. In some embodiments, the apparatus includes a plurality of portions that each have a spatial relationship with respect to the apparatus, and each device includes a location on at least one of the portions of the apparatus. The remote controller can include a body that has portions corresponding respectively to portions of the apparatus, and each controller portion can have a spatial relationship with respect to the body that is similar to the spatial relationship of a corresponding apparatus portion with respect to the apparatus. In such embodiments, a switch can be located on a first body portion and can be operable to control a device on the apparatus, the device being located on a first apparatus portion that corresponds to the first body portion.

The present invention also provides a method for remotely controlling a device on an apparatus. This method can include the following steps: identifying a portion of an apparatus to be controlled, in which the portion to be controlled has a first spatial relationship with respect to other portions of the apparatus, selecting a portion of a remote control from a plurality of portions of the remote control, wherein the selected portion of the remote control has a second spatial relationship with respect to other portions of the remote control that is similar to the first spatial relationship, operating a switch on the selected portion of the remote control, transmitting at least one signal from the remote control to the apparatus in response to operation of the switch, receiving the at least one signal at the apparatus, and activating a device associated with the portion of the apparatus.

Other features and advantages of the invention will become apparent to those skilled in the art upon review of the following detailed description, claims, and drawings.

### BRIEF DESCRIPTION OF THE DRAWINGS

The present invention is further described with reference to the accompanying drawings, which show certain embodiments of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention.

In the drawings, wherein like reference numerals indicate like parts:

FIG. 1 is a schematic illustration of an embodiment of the present invention;

FIG. 2 is a schematic illustration of an alternative embodiment of the present invention;

FIG. 3 is a schematic illustration of another alternative embodiment of the present invention;

FIG. 4 is a top perspective view of an integrated key according to an embodiment of the present invention;

FIG. 5 is a bottom perspective view of the integrated key of FIG. 4;

FIG. 6 is a top view of the integrated key of FIG. 4;

FIG. 7 is a side view of the integrated key of FIG. 4;

FIG. 8 is a left perspective view of a vehicle that is suitably configured for operation with the integrated key of FIG. 4; and

FIG. 9 is a right perspective view of the vehicle of FIG. 8.

Before the various embodiments of the invention are described in detail, it is to be understood that the present invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items. The use of “consisting of” and variations thereof herein is meant to encompass only the items listed thereafter.

### DETAILED DESCRIPTION

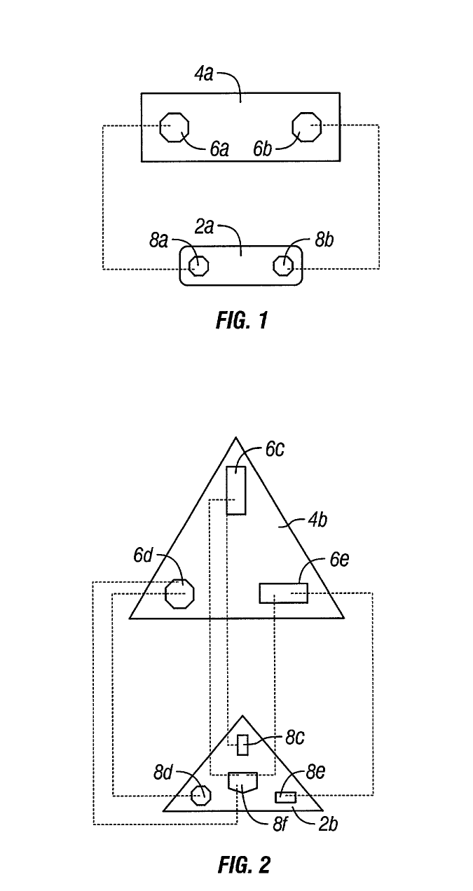

FIGS. 1-3 schematically illustrate three embodiments of the present invention. In each illustrated embodiment, a remote control 2a-2c is operable to control one or more devices 6a-6e and 6g-6j of an apparatus 4a-4c. The apparatus can be any apparatus having one or more devices that can be adapted to be remotely controlled. By way of example only, the apparatus can be a TV, VCR, DVD player, stereo, fan, door, window, computer, light, toy, appliance, answering machine, furnace, air conditioner, HVAC equipment, alarm system for auto, home, or office, and the like. In some cases, the apparatus can even be a home, building, vehicle, assembly, or other large structure that has devices adapted to be remotely controlled. For example, a home can have doors and/or windows that can be opened or closed remotely, lights that can be turned on or off remotely, an alarm system that can be remotely armed and disarmed, a heating and air conditioning system that can be changed remotely, a garage door that can be opened and closed remotely, and the like.

The remote control 2a-2c can be employed to control any such device, mechanism, or system 4a-4c in one or more different manners, such as the operational state of the device, mechanism, or system 4a-4c (e.g., speed, powered or armed state, position, orientation, brightness, loudness, and the like), one or more functions or operations of the device, mechanism, or system 4a-4c, and the like.

FIG. 1 illustrates an example of a control mechanism 2a and associated apparatus 4a that is configured and operates according to an embodiment of the present invention. As illustrated, the apparatus 4a has a generally rectangular shape or contour and includes two schematically illustrated devices and/or mechanisms 6a, 6b that perform a function associated with operation of the apparatus 4a. The control mechanism 2a has a shape that resembles the apparatus 4a (in the illustrated example, a generally rectangular shape or contour). Note that the control mechanism 2a need not necessarily have exactly the same shape or contour as the apparatus 4a in order to “resemble” the apparatus 4a, and in some embodiments has a somewhat modified representation thereof. In some embodiments, the control mechanism 2a resembles the apparatus 4a only with such sufficiency to help a user identify the proper orientation of the control mechanism 2a and portions of the control mechanism 2a that correspond to portions of the apparatus 4a. In some cases, the resulting control mechanism shape is significantly different from the shape of the apparatus 4a, but still enables a user to readily identify the corresponding portions of the control mechanism 2a and the apparatus 4a.

It should be noted that for an apparatus 4a having a relatively simple shape, e.g. a VCR or television, the degree to which the control mechanism 2a resembles the apparatus can be heightened. Alternatively, if the apparatus 4a has a more complex shape or contour (such as a house or a vehicle), the resemblance between the apparatus 4a and the control mechanism 2a can decrease. In this respect, the degree to which the control mechanism 2a resembles the apparatus 4a is generally a function of the specific application and can vary widely. In some embodiments, the control mechanism 2a resembles the apparatus 4a from a single direction or from only a few viewing directions, while in other embodiments, the control mechanism 2a can resemble the apparatus 4a from substantially any viewing direction.

Schematically illustrated on the control mechanism 2a are two switches 8a, 8b that remotely communicate with an associated one of the devices 6a, 6b on the apparatus 4a. The switches 8a, 8b are positioned on the control mechanism 2a at locations that substantially correspond to the positions of the devices 6a, 6b on the apparatus 4a. In the embodiment illustrated in FIG. 1, the switches 8a, 8b can be substantially any type or style of user-manipulatable control (i.e., “switch” as described below), such as push-buttons, toggle switches, rotary dials, joysticks, and the like.

The apparatus 4a illustrated in FIG. 1 is an apparatus that has a generally rectangular shape when viewed at least from one viewing angle. Accordingly, the remote control 2a also has a generally rectangular shape when viewed at least from one viewing angle. By way of example only, the apparatus 4a can be a stereo receiver having a volume control knob 6a located at a left vertically centered front location on the receiver and a tuner control knob 6b located at a right vertically centered front location on the receiver. The remote control 2a can have controls (e.g., dials, buttons, levers, or any other user-manipulatable devices) located in corresponding positions on the rectangular face of the remote control 2a. Therefore, a user-manipulatable control 8a corresponding to and operable to adjust the volume control 6a of the receiver can be located at a left vertically centered location on the remote control 2a, while a user-manipulatable control 8b corresponding to and operable to adjust the tuner control 6b of the receiver can be located at a right vertically centered location on the remote control 2a. A user can therefore quickly identify a particular control on the remote control 2a needed to change a device of the apparatus 4a by identifying or knowing the location of the device on the apparatus.

In some embodiments, a user's intuition regarding the location of the device to be remotely controlled is not the actual location of the device, but rather the location of a user-manipulatable control on the device. For example, in the remotely-controlled stereo receiver described above, a user intuitively knows to manipulate the left control 8a on the remote control 2a to adjust the receiver volume by knowing or identifying the location of a volume control knob 6a on the receiver 4a, even though the device that actually generates the change in volume can be located elsewhere in the receiver (e.g., amplification and control circuitry coupled to the volume control knob 6a and located elsewhere inside the housing of the receiver 4a).

Accordingly, in some embodiments of the present invention, it is more intuitive for a user-manipulatable control 8a, 8b on the remote control 2a to be located in a position corresponding to a control on the apparatus rather than to the actual device itself. Therefore, elements 6a and 6b in FIG. 1 can refer to controls used to operate devices on the apparatus 4a or to the devices themselves. In this regard, it should be noted that in some cases, the location of the control on the apparatus 4a is the same location as the device that the control operates. Also, in some cases the device to be remotely controlled has no other control associated with it, in which case the physical location of the device on the apparatus can be used to determine where the corresponding user-manipulatable control 8a, 8b should be located on the remote control 2a.

FIG. 2 illustrates a second embodiment of the present invention that incorporates additional aspects of the present invention. As illustrated, the apparatus 4b and control mechanism 2b of FIG. 2 are generally triangularly shaped and the control mechanism 2b is shaped to resemble the apparatus 4b. The devices 6c, 6d, 6e of the apparatus 4b are remotely controlled by respective switches 8c, 8d, 8e of the control mechanism 2b. As with the embodiment illustrated in FIG. 1, the switches 8c, 8d, 8e are positioned on the control mechanism 2b in locations corresponding to the positions of the devices 6c, 6d, 6e on the apparatus 4b, and can be any type of user-manipulatable control. An additional switch 8f is provided on the control mechanism 2b and communicates with one or more of the devices 6c, 6d, 6e (e.g. all three devices as illustrated) to simultaneously or substantially control, adjust, or otherwise operate the devices 6c, 6d, 6e, or to control all three devices 6c, 6d, 6e in a coordinated manner (i.e., one after the other in succession, two at once followed by a third, and the like). In this respect, multiple devices can be controlled using a single switch, and with a single operation (e.g. depressing the switch 8f), and a single device can be controlled by more than one switch. Because the switch 8f controls several devices 6c, 6d, 6e, the switch 8f can be positioned in a generic location on the control mechanism 2b that does not necessarily correspond to the location of the devices 6c, 6d, 6e on the apparatus 4b. Like the other switches 8c, 8d, 8e, the switch 8f can be substantially any type or style of user-manipulatable control.

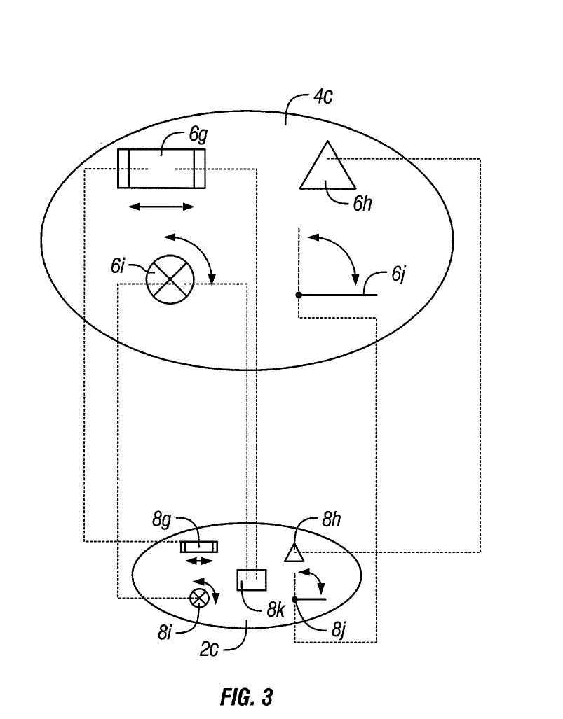

FIG. 3 illustrates a third embodiment of the present invention that incorporates still further aspects of the present invention. By way of example only, the apparatus 4c and control mechanism 2c are shown as having similar oblong shapes (although any other shape can be employed as desired). As with the embodiments illustrated in FIGS. 1 and 2, the control mechanism 2c has a shape resembling the apparatus 4c. The devices 6g, 6h, 6i, 6j are controlled or otherwise operated by respective switches 8g, 8h, 8i, 8j positioned on the control mechanism 2c in locations corresponding to the positions of the devices 6g, 6h, 6i, 6j on the apparatus 4c. An additional switch 8k is provided in a generic location on the control mechanism 2c and communicates with the devices 6g, 6i for simultaneous or substantially simultaneous control thereof or for any desired coordinated control of the devices 6g, 6i. Alternatively, the additional switch 8k can communicate with any or all of the devices 6g-6j in accordance with the above teachings.

The embodiment of the present invention illustrated in FIG. 3 provides an example regarding how a particular motion or function of a user-manipulatable control 6g, 6h, 6i, 6j on the control mechanism 2c can mimic or otherwise be similar in one or more manners to the motion or function of a device 6g, 6h, 6i, 6j on the apparatus 4c. For example, the device 6g on the apparatus 4c is configured to translate with respect to the apparatus 4c. As other examples, the device 6i is rotatable with respect to the apparatus 4c, while the device 6j is movable between first and second positions on the apparatus 4c. It will be appreciated that the ranges of mobility of the devices 6g, 6i, 6j illustrated in FIG. 3 are provided as schematic representations of possible motions and functions associated with substantially any apparatus.

The switches 8g, 8i, 8j in the embodiment illustrated in FIG. 3 are configured such that operation of the switches 8g, 8i, 8j includes manipulating the switches 8g, 8i, 8j in a way that is similar to or mimics the movement or function of their respective devices 6g, 6i, 6j. In this respect, the switch 8g is translatable with respect to the control mechanism 2c, the switch 8i is rotatable with respect to the control mechanism 2c, and the switch 8j is movable with respect to the control mechanism 2c between first and second positions. Thus, the location and operation of each switch 8g, 8h, 8i, 8j is somewhat intuitive to an operator who is familiar with the operation of the apparatus, but who may be unfamiliar with the control mechanism 2c. The intuitive placement and operation of the switches can be highly advantageous in situations where it is unreasonable to expect an operator to learn the nuances of a complicated control mechanism.

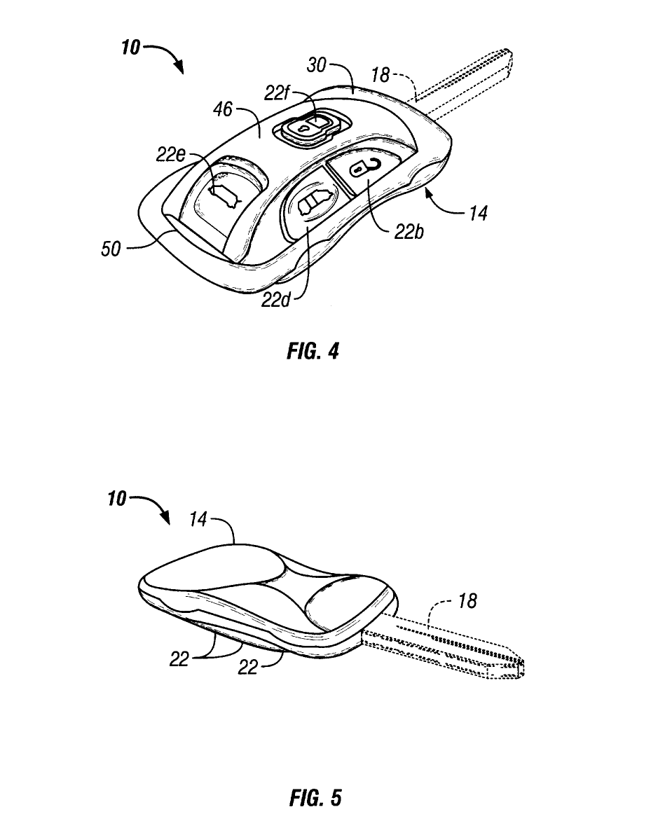

An example of a remote control according to the present invention is illustrated in FIGS. 4-7. Although a remote control according to the present invention can be used to control one or more devices on any apparatus as discussed above, the remote control illustrated in FIGS. 4-7 is a remote control for a vehicle. Specifically, FIGS. 4 and 5 illustrate a control mechanism in the form of a remote control unit and optional key integrated into a single assembly (hereinafter an “integrated key”) 10 for controlling various devices, mechanisms, and operations of an apparatus such as, for example, a passenger vehicle. The integrated key 10 can include a housing 14, an optional key protrusion 18 (illustrated in phantom), and a plurality of switches 22a-22g on the housing 14. The housing 14 substantially comprises a remote key fob for remotely controlling the devices and mechanisms which perform or otherwise carry out operations and functions on the passenger vehicle. It will be appreciated that the key protrusion 18 is an optional feature of the remote control device illustrated in FIGS. 4-7. In other embodiments, the device illustrated in FIGS. 4-7 is a fob having no key directly coupled to the housing 14. In this respect an additional, otherwise conventional key including a key protrusion could be provided along with the integrated key 10 if required.

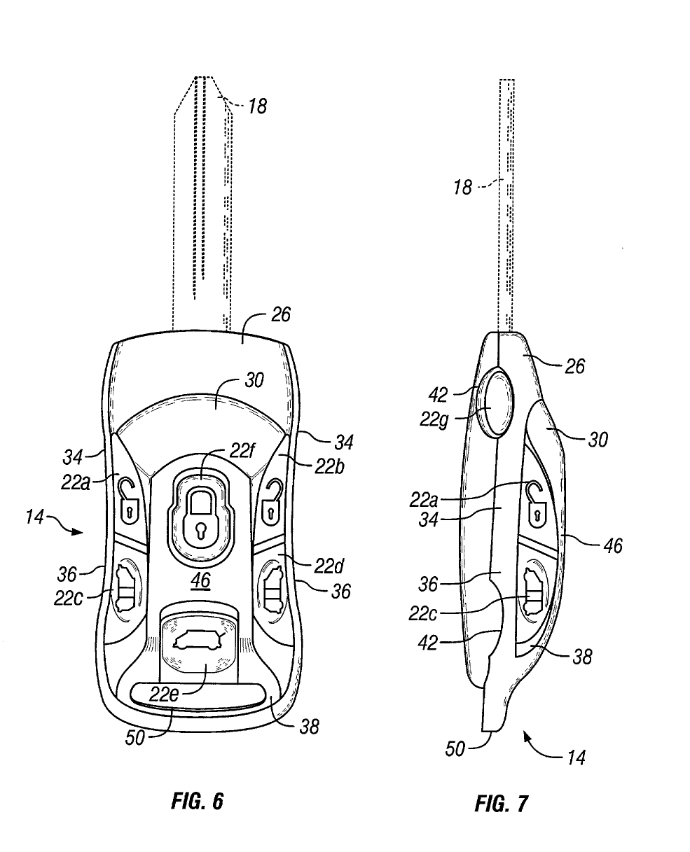

If With reference also to FIGS. 6 and 7, the illustrated housing 14 includes an outer surface that is generally shaped to resemble a passenger vehicle, and more can be generally shaped to resemble a passenger vehicle similar to the vehicle associated hi with the integrated key 10 or sharing features similar to those of the vehicle. In the illustrated embodiment for example, the housing 14 includes portions resembling or corresponding to a hood 26, a windshield 30, front doors 34, rear doors 36, a lift gate 38, wheel wells 42 and a roof 46. If desired, the housing 14 can include a hook portion 50, aperture, or other feature suitable for securing the housing 14 to a key ring, chain, or other connecting element. The hook portion 50 can be integral with the housing 14 or can be a separate element attached to the housing 14 in any manner, such as by one or more conventional fasteners, adhesive or cohesive bonding material, a snap-fit, inter-engaging elements, and the like.

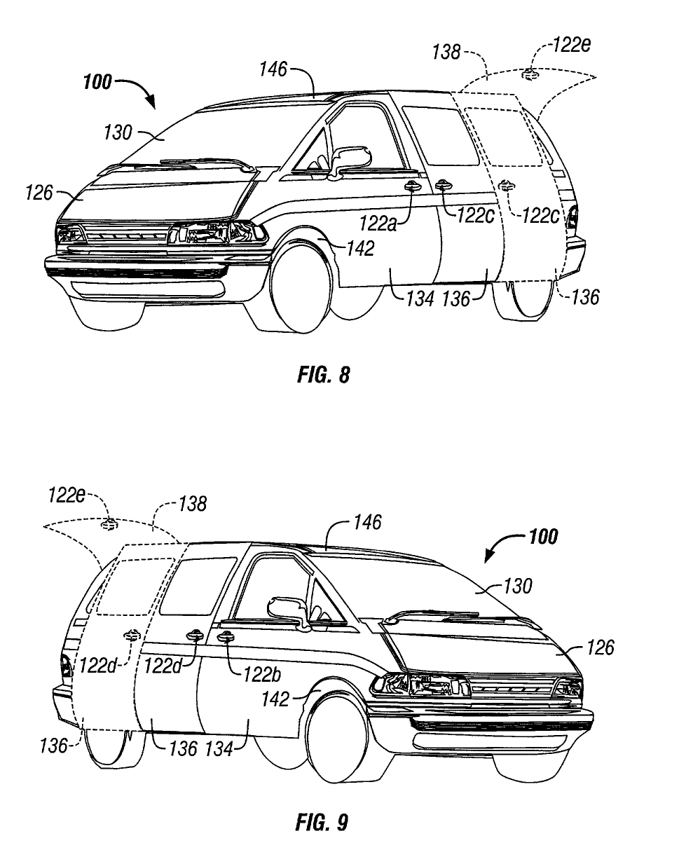

FIGS. 8 and 9 illustrate a passenger vehicle 100 that is adapted to be controlled by the integrated key 10. While the vehicle 100 forms no part of the present invention, it is further described herein to clarify the operation and configuration of the integrated key 10. The illustrated passenger vehicle 100 is a vehicle generally known as a “mini-van” although the key 10 is suitable for use with substantially any vehicle including without limitation cars, buses, motorcycles, trucks, tractors, heavy equipment, and any of the other vehicles or devices described in the Background above.

The illustrated vehicle 100 includes various components that are common among automobiles, including a hood 126, a windshield 130, front doors 134, rear doors 136, a lift gate 138, wheel wells 142 and a roof 146. As mentioned above, the housing 14 of the integrated key 10 can be shaped to resemble the vehicle 100. Accordingly, one or more of the various housing portions 26, 30, 34, 36, 38, 42, and 46 can correspond to and resemble respective components 126, 130, 134, 136, 138, 142, and 146 of the vehicle. Thus, reference numerals assigned to the vehicle portions in the present application are the same as those assigned to their corresponding housing portions, increased by one hundred.

Certain components of the vehicle 100 are movable or otherwise adjustable between various states or configurations. For example, the rear doors 136 can be of the sliding type such that they are slidable between an open configuration and a closed configuration (see FIGS. 8 and 9). Similarly, the front doors 134 and the lift gate 138 can be adjustable between open and closed configurations (also shown in FIGS. 8 and 9). In general, the front doors 134, the rear doors 136, and the lift gate 138 provide access to the interior of the vehicle 100.

As is well known in the vehicle industry, it is preferred for each of the vehicle doors and the lift gate to be lockably securable in their closed configuration. In this respect, each component, e.g. both front doors 134, both rear doors 136, and the lift gate 138 may include a locking mechanism 122a-122e that is operable to selectively lock, latch, or otherwise secure the component in the closed configuration. In many applications, the locking mechanisms 122a-122e (which can sometimes include locking latches) are electromechanical devices that are operable by push buttons or other controls located within the vehicle 100. Such locking mechanisms are commonly referred to as power locks. In this respect, the mechanisms 122a-122e are generally also operable to unlock or unlatch their respective components, such that the components may be opened. Although the mechanisms 122a-122e are typically positioned on or near their respective components (e.g. the doors 134, 136 and the lift gate 138), it will be appreciated that the mechanisms 122a-122e can be positioned completely or partially on or in other portions of the vehicle interior or exterior, or completely or partially within other vehicle components that are remote from their respective components.

In some vehicles 100, mechanism 122a is operable to lock and unlock a left front door 134, and mechanism 122b is operable to lock and unlock a right front door 134. Similarly, mechanisms 122c and 122d can be operable to lock and unlock the rear doors 136 in some vehicles. Also in some vehicles 100, mechanisms 122c and 122d are further operable to automatically open and close their respective rear doors 136. In the illustrated vehicle 100 for example, opening the rear doors 136 generally comprises sliding the doors 136 rearwardly to permit access to the vehicle 100 interior. In this respect, mechanisms 122c and 122d can comprise both a locking mechanism for door locking and/or unlocking functions and an actuating mechanism for door opening and/or closing functions. Accordingly, each such mechanism (or their combination) can comprise multiple operating components for performing such functions. With further reference to the mini-van illustrated in FIGS. 8 and 9, one or more mechanisms 122e are operable to lock and unlock a lift gate 138, to automatically open and close the lift gate 138, or to perform both functions. In this regard, such mechanism(s) can be used to open, close, lock, or unlock a trunk or another type of rear door, or to perform any combination of these functions.

The user-manipulatable elements 22a-22g illustrated in FIGS. 4-7 and described herein are referred to as “switches”. As will be described in greater detail below, the elements 22a-22g can take a number of different forms, each one of which is operable by a user to input a command to the integrated key 10. By way of example only, the elements 22a-22g can be buttons, keys, slides, toggle or throw-switches, knobs, levers, dials, joysticks, or any other type of element, device, or structure (or any combination of such elements, devices, or structures) that can be manipulated by a user to input a command to the integrated key 10. The term “switch” as used herein and in the appended claims is intended to encompass all such elements, devices, and structures, including those listed above with respect to FIGS. 1-3.

With continued reference to the illustrated embodiment of FIGS. 4-7, each switch 22a-22e is configured to remotely activate or control a respective one of the locking mechanisms 122a-122e. The remaining switches 22f and 22g remotely activate or control multiple or alternate mechanisms or devices of the vehicle 14, as will be described further below. As used herein and in the appended claims, the terms “control”, “activate” and “activating” refer to operation of a device, element, or structure regardless of the complexity involved in such operation. For example, such operation can include the initiation or implementation of single-function operations (such as on/off operations, open/close operations, and the like), or can instead include more complicated operations requiring the execution, initiation, or implementation of a plurality of steps, instructions, or operations (such as the movement, adjustment, and reconfiguration of multiple devices, items, or mechanisms in specific or nonspecific order). In addition, the term “control” includes the termination or halting of such operations at any time.

In the embodiment of FIGS. 4-7, the switches 22a, 22b are positioned on the housing 14 on or generally near the portions 34 that resemble or represent the front doors 134 of the vehicle 100. Accordingly, the switches 22a, 22b are configured to remotely communicate with the mechanisms 122a and 122b such that in response to operation of one of the switches 22a, 22b, a respective one of the mechanisms 122a, 122b locks or unlocks a corresponding front door 134 of the vehicle 100. In this way, the left and right front doors 134 can be individually locked or unlocked using the integrated key 10. In the illustrated embodiment, the switches 22a, 22bcomprise push buttons that are operable by depressing the switches 22a, 22b. However, as discussed above, other types and configurations of switches can instead be employed as desired.

The switches 22a, 22b can be configured to operate in a mode wherein depressing a switch (switch 22a, for example) unlocks the left front door 134, and depressing the switch 22b unlocks the right front door 134. Of course, many alternative operating sequences are possible, such as prolonged depression, double-depression, rapid sequential depression, or any other manner of operating either or both switches 22a, 22b either alone or in combination. By way of example only, the key 10 can be configured so that depressing the switch 22a twice within a relatively short period of time generates unlocking of both front doors 134 as well as the rear doors 136. As another example, the key can also or instead be configured so that brief depression of either switch 22a, 22b causes only the corresponding front door 134 to unlock, while continued depression of either switch 22a, 22b causes both front doors 134 to unlock. Still other switch configurations and manners of switch operation are possible, some of which are well known to those skilled in the art. All such switch configurations and manners of switch operation fall within the spirit and scope of the present invention.

With continued reference to the embodiment of the present invention illustrated in FIGS. 4-7, switches 22c and 22d are positioned on the housing 14 and are configured in accordance with the teachings set forth above with respect to switches 22a and 22b. As such, the switches 22c and 22d are positioned on the housing 14 in the vicinity of the housing portions 36 that resemble the rear doors 136 of the vehicle 100. Like the switches 22a, 22b above, each switch 22c, 22d communicates with a respective one of the door mechanisms 122c, 122d, such that in response to operation of one of the switches 22c, 22d, a respective one of the mechanisms 122c, 122d locks or unlocks a corresponding rear door 136. Furthermore, because the mechanisms 122c, 122d (which can each comprise several mechanisms performing different door functions) can also be operable to open and close the rear doors 136, the switches 22c, 22d in some embodiments are configured to provide control for such operations as well.

In contrast to the button-type switches 22a, 22b described above and illustrated in the figures, some embodiments of the present invention (for example, those embodiments configured for use with a minivan) include switches 22c and 22d that are slidable with respect to the housing 14. In this respect, sliding movement of the switches 22c and 22d corresponds to and can even mimic the sliding movement required to manually open and close the rear doors 136 of the vehicle 100. In some embodiments, the switches 22c and 22d are biased toward a central position with respect to the housing 14 (such as by an internal leaf, coil, torsion, or other spring attached to the switches 22c, 22d, by a resilient mount, pad, substrate, or other resilient element beneath each switch 22c, 22d or otherwise oriented with respect to each switch 22c, 22d to provide a biasing force thereagainst, and the like).

When either slidable switch 22c, 22d of the embodiment illustrated in FIGS. 4-7 is actuated to slide rearwardly with respect to the housing 14, a corresponding rear door 136 of the vehicle 100 is opened. Specifically, such sliding movement results in operation of the switch 22c, 22d and subsequent unlocking and opening of the corresponding rear door 136. Similarly, when either slidable switch 22c, 22d is actuated to slide forwardly with respect to the housing 14, a corresponding rear door 136 of the vehicle 100 is closed (e.g. by an electric motor, a suitable mechanical, pneumatic, or hydraulic actuator, or a combination thereof, and the like). Of course the rear door 136 can also be opened and closed manually if so desired. In addition, some embodiments of the invention may be slidable in a single direction corresponding to opening or closing of the rear doors 136.

In alternative embodiments of the present invention, the switches 22c, 22d are dual-position switches, such that each switch 22c, 22d is detently engageable in a forward position corresponding to closure of the corresponding rear door 136 and/or in a rearward position corresponding to opening of the corresponding rear door 136. In still further embodiments, the switches 22c, 22d can be combination sliding/push button switches. In this respect, such switches 22c, 22d are slidable in substantially the same manner and achieve substantially the same result as the various sliding switches described above. In addition however, when such switches 22c, 22d are in their centrally biased, forwardly biased, or detently engaged positions, the switches 22c, 22d can also be depressed, in which case the switches 22c, 22d can be operable similarly to the switches 22a, 22b described above in order to lock and unlock the rear doors 136. Also or alternatively, if a rear door 136 is open, depression of a corresponding switch 22c, 22d can result in operation of the corresponding device 122c, 122d to move the rear door 136 to its closed position and to subsequently lock the rear door(s) 136. One having ordinary skill in the art will appreciate that still other manners of switch actuation and operation are possible, each one of which falls within the spirit and scope of the present invention.

Of course, not all vehicles are configured like the vehicle 100 (mini-van) illustrated in FIGS. 8 and 9. Accordingly, a number of alternative manners of operating the switches 22c, 22d are possible to control locking and unlocking operations and/or to open and close the corresponding rear door(s) 136 of the vehicle 100. For example, 4-door vehicles, which have doors generally only opened and closed manually, can also be controlled by the switches 22c, 22d, in which case the switches would likely only control the locking and unlocking of the doors. Control of 4-door vehicles having mechanisms for automatically opening and closing the doors are also contemplated. In the event the vehicle is a 2-door vehicle, the switches 22c, 22d can be eliminated from the housing 14 altogether. Furthermore, rear-door switches 22c, 22d can be actuated in any number of different manners (as described above with reference to switches 22a, 22b) to perform a number of different functions associated with the rear doors 136 of the vehicle 100. For example, the switches 22c, 22d can be actuated rapidly, can be depressed for a prolonged period, or can be operated in a number of other manners to perform different functions upon the vehicle.

With continued reference to the embodiment of the present invention illustrated in FIGS. 4-7, the switch 22e is positioned on the housing 14 on or in the vicinity of the portion 38 of the housing 14 that resembles the vehicle lift gate 138. Accordingly, and in keeping with the above teachings, the switch 22e can communicate with the mechanism 122e to control the lift gate 138. Much like the mechanisms 122c and 122d, the device 122e (which can comprise several mechanisms performing different lift gate functions) can also be operable to lock, unlock, open, and/or close the lift gate 138. As such, the specific operation of the switch 22e can be such that the motion associated with switch operation corresponds to and can even mimic or resemble the resultant motion of the lift gate 138.

In some embodiments of the present invention, the switch 22e is slidably mounted to the housing 14 such that the switch 22e is operable in a manner similar to the switches 22c and 22d. In this respect, sliding the switch 22e upwardly and forwardly can result in operation of the device 122e to unlock and subsequently open the lift gate 138. As previously mentioned with respect to the switches 22c and 22d, the switch 22e can be biased toward one position, or can include a detent arrangement to detently secure the switch 22e in one or more certain positions corresponding to the positions of the lift gate 138. In other embodiments, the switch 22e can be pivotable with respect to the housing such that pivoting the switch 22e in one direction unlocks and subsequently opens the lift gate 138, and pivoting the switch 22e in an opposite direction closes and subsequently locks the lift gate 138.

Of course, if the vehicle 100 is a conventional automobile rather than a minivan as illustrated in FIGS. 8 and 9, the switch 22e can be configured to operate another device of the automobile (e.g., the automobile trunk or hatchback), or can be eliminated altogether. In other embodiments of the invention, the switch 22e can comprise a push button and can be operable simply to unlock and/or open the lift gate 138. In such an embodiment, the switch 22e can be configured to be depressed once to unlock the lift gate 138 and depressed a second time to open the lift gate 138, can be configured to be depressed once to unlock the lift gate 138 and depressed a prolonged time to open or unlock and open the lift gate 138, or can be configured in a variety of other operating manners and sequences to generate different results and to control the lift gate 138 in other ways.

Although several of the switches (22a-22e) of the illustrated embodiment described above are actuatable to unlock, lock, open and/or close a door 134, 136 or lift gate 138, other switches can be provided on the housing 14 to communicate with additional mechanisms for opening, closing, locking, unlocking, activating, deactivating, or otherwise controlling other vehicle components. One example of such an additional switch is a switch configured to control the state and position of the hood 126 of the vehicle 100. Such a switch could be located on the portion 26 of the housing 14 that resembles the hood 126 of the vehicle 100. Another example of such an additional switch is a switch configured to lock, unlock, open and/or close a fuel door on the vehicle 100. Such a switch could be located on the portion of the housing 14 resembling a fuel door. Still another example of an additional switch is a switch configured to remotely start the vehicle's engine. Such a switch might also be located on the portion 26 of the housing 14 that resembles the hood 126 of the vehicle 100. In general, any type or style of switch can be positioned on the housing 14 in an area that generally corresponds to the position on the vehicle 100 of the component that the switch controls. All such switches and their location upon the integrated key 10 fall within the spirit and scope of the present invention.

With reference again to the illustrated embodiment of FIGS. 4-7, switch 22f is configured to communicate with each device 122a-122e and is operable to simultaneously lock the front doors 134, the rear doors 136, and the lift gate 138. Switch 22f differs from switches 22a-22e in that switch 22f is not positioned on the housing 14 in a position corresponding to the location of the device the switch 22f controls. As illustrated, the switch 22f in the embodiment of FIGS. 4-7 is positioned on the portion 46 that substantially resembles the vehicle roof 146. Although the switch 22f (or any other switch that has no identifiable position on the housing 14 corresponding to a particular device or location on the vehicle 100) can be positioned substantially anywhere on the housing 14, the illustrated switch 22f is in a location that does not create unnecessary confusion with respect to the vehicle operation the switch 22f is configured to control.

In the illustrated embodiment for example, the switch 22f simultaneously locks the various vehicle components, although in some embodiments switch 22f can also be operable to unlock the vehicle components. The switch 22f can also or instead be configured to initiate various other vehicle operations based upon the manner in which the switch 22f is manipulated (e.g., repeated depressions, a prolonged depression, sliding of the switch 22f in one or more different directions, and the like). For example, in some embodiments, depressing the switch 22f once locks the vehicle doors 134, 136 and lift gate 138, while depressing the switch 22f a second time arms a vehicle security system. Such arming of the security system can be signaled to the operator by, for example, a short blast of the vehicle horn and/or flashing of the vehicle lights.

Although any or all of the switches 22a-22f of the integrated key 10 can be unlabeled or can otherwise be void of indicia or other information for a user, each switch 22a-22f described above can instead or in addition be shaped and/or include an icon printed thereon such that the vehicle operation that the particular switch controls is relatively apparent to an operator. Alternatives to icons include text, other graphics, and the like. By way of example only, the switches 22a and 22b illustrated in the figures include icons representative of an unlocking operation. Similarly, the switches 22c and 22d illustrated in the figures include icons representative of a door-opening operation, while the switches 22e and 22f illustrated in the figures include icons that also make the associated vehicle operation relatively clear to an operator. Thus, the integrated key 10 can include a plurality of switches that are positioned, configured, and labeled to afford intuitive operation of the switches in order to control various vehicle components.

As indicated above, in some embodiments, the integrated key can include one or more switches that do not have a single associated location on a vehicle 100 or that have no associated location on a vehicle 100. For example, switch 22g in the illustrated embodiment does not generally correspond to the vehicle location of the component that switch 22g controls. Switch 22g is what is known in the art as a “panic button.” Specifically, switch 22g is configured such that depression or activation of the switch 22g causes the vehicle lights to flash and the vehicle horn to sound repeatedly. The panic button is intended to allow an operator to draw attention to the vehicle if the operator so desires. Because the panic button controls vehicle components that are located throughout the vehicle, positioning the switch 22g on the housing 14 in a location generally corresponding to the location of the components on the vehicle 100 is somewhat precluded.

Accordingly, the switch 22g in the illustrated embodiment is positioned on the housing 14 on or in the vicinity of the housing portion 42 that resembles one of the vehicle wheel wells 142. Such position is generally chosen for aesthetic and/or design reasons. In some embodiments, the word “PANIC” is displayed on the housing 14 near the switch 22g to clarify the function and operation of the switch 22g. While the illustrated switch 22g does not carry an icon or other indicia, the switch 22g could instead be configured to display such an icon or indicia, such as, for example, an exclamation mark or a horn.

In some embodiments, such as the embodiment shown in FIGS. 4-7, the housing 14 and the switches 22a-22g are configured so that the switches 22a-22g are at least partially recessed with respect to the outer surface of the housing 14. In this respect, the likelihood of unintentional operation of the switches is reduced. In addition, such a recessed configuration also generally improves the overall aesthetic appeal of the integrated key 10. It should be appreciated that any or all of the above described switches may be provided on a single housing 14 as desired for a particular application. In addition to the examples presented above, other vehicle components or features that can or could otherwise be controlled by various types of switches include vehicle lights (both interior and/or exterior), vehicle windows, vehicle seats, vehicle mirrors, vehicle climate control systems, vehicle suspension systems (e.g. to lower the vehicle for entry), vehicle sunroofs and convertible tops, vehicle sound systems, and substantially any other vehicle component, function, or operation, without limitation.

The optional key protrusion 18 is conventional in nature, and is machinable to provide any desired key profile. The key protrusion 18 is insertable into the locks and ignition of the vehicle 100 in order to lock and unlock the various doors 134, 136, lift gate 138, or other parts of the vehicle 100 as well as to activate and deactivate the ignition of the vehicle 100 as is well known in the art. In some embodiments, the key protrusion 18 is retractable or foldable with respect to the housing 14 such that the housing 14 substantially surrounds the key protrusion 18 in one state of the key protrusion 18, or such that the key protrusion 18 lies generally adjacent to the housing 14 in one state of the key protrusion 18. Such foldability and/or retractability can reduce the size of the integrated key 10, thereby making the key 10 easier to carry and store. In some embodiments of the invention, the key protrusion 18 is completely removed from the housing, such that the housing 14 and an additional, separate key are provided for operation of the vehicle 100.

As described above, the integrated key 10 can be employed to remotely control devices on a number of different vehicle types. For example, the integrated key 10 can be employed to remotely control devices on automobiles (2 and 4-door, convertible or non-convertible, and the like), trucks (e.g., pick-up trucks, utility trucks, flat-beds, extended cabs having one or more rear doors, etc.), vans, mini-vans, sport utility vehicles, and the like. In this regard, the number, types, and functions of switches 22 on the housing 14 can be significantly different than that illustrated in FIGS. 4-7. By way of example, a two-door automobile or a two-door pickup truck can have two door switches 22a, 22b for unlocking and/or locking the vehicle doors 134, a van having a single side door, two front doors, and two rear doors can have five dedicated door switches for unlocking and/or locking each door, and the like. The integrated key 10 can therefore be provided with any number of switches 22 in different locations on the housing 14 to reflect the corresponding locations of vehicle devices operable by such switches 22. If desired, one or more additional switches can be located in other areas of the housing 14, each of such additional switches capable of controlling two or more devices on the vehicle (e.g., in a manner similar to the switch 22f in the illustrated embodiment).

In addition, the various switches 22 on the housing 14 can be adapted to operate any number of different devices on the vehicle. For example, a switch 22 can be located on the front or rear of the housing 14 for controlling the front and/or rear lights of the vehicle 100, a switch 22 can be located on the top of the housing 14 for controlling an interior light of the vehicle 100 or a sunroof of the vehicle 100, a switch can be located on the rear of the housing 14 for locking, unlocking, opening, and/or closing a trunk, tailgate, or hatchback of the vehicle 100, one or more switches 22 can be located on the sides of the vehicle 100 for controlling one or more windows of the vehicle 100, a switch 22 can be located on the top front of the housing (i.e., corresponding to the location of the vehicle's engine or to the ignition of the vehicle 100) for starting or stopping the vehicle's engine, a switch 22 can be located on the front of the housing 14 for operating the vehicle's horn, and the like. The housing 14 can have any number of other switches 22 positioned in locations corresponding to any device on or in the vehicle 100 for remotely controlling such device(s).

Although the integrated key 10 in the illustrated embodiment has several switches 22 for remotely operating several devices 122 on a vehicle 100, other embodiments can have can have fewer or more switches 22 for operating any number of devices 122 of the same or different type. For example, the housing 14 can have a single button for unlocking and/or locking all doors 134, 136 of a vehicle 100. In other embodiments, the housing 14 can have more switches 22 than shown in FIGS. 4-7 for controlling more devices 122 on the vehicle 100.

In some embodiments (such as the illustrated embodiment described above), the housing 14 of the integrated key 10 has the shape of a vehicle 100. This shape can be the shape of any vehicle 100, and need not necessarily match the shape of the vehicle 100 which is associated with the integrated key 10. However, in some embodiments, the housing 14 resembles the vehicle 100 associated with the integrated key 10, and can be a modified or simplified version of the shape of the vehicle 100 (e.g., streamlined, flatter, sleeker, and the like). In other embodiments, the housing 14 does not resemble the shape of a vehicle 100 or the vehicle 100 associated with the integrated key 10. In some of these embodiments, the various switches 22 can still be in locations on the housing 14 corresponding to the locations of devices 122 controlled by the switches 22 as described above. By way of example only, a round or rectangular housing 14 can have switches 22 on opposite sides corresponding to and controlling door locks and/or door windows on opposite sides of the vehicle 100. As another example, such a housing 14 can have a switches 22 on opposite ends of the housing 14 for operating a rear door lock and headlights of the vehicle, respectively. Therefore the housing 14 according to the present invention can have any shape desired while still having switches 22 located in positions thereon corresponding to positions of devices 122 on the vehicle 100.

While the exemplary drawings and description above have thus far been directed toward a vehicle and a corresponding integrated remote key, the teachings of the invention are applicable to substantially any device that remotely controls any apparatus, as discussed above with respect to FIGS. 1-3. By way of example only, a remote system for controlling various operations of a house might be provided. The system can include a hand-held controller contoured to resemble the house and having switches located in accordance with the above teachings. The switches can be operable to control opening and closing of garage doors, locking and unlocking of doors and windows, switching on and off of lights, as well as additional functions, all of which fall within the spirit and scope of the present invention. As another example, a remote system for controlling various household electronic devices or appliances might be provided. One specific example of such a system might include a housing contoured to resemble a stove-top/oven combination. Switches operable to control the heat level of the burners could be provided in appropriate locations on the housing, as could switches to control the heat level of the oven. Other household appliances or home electronics could be controlled by a similarly configured device.

As presented above, the invention may take the form of substantially any object, device, or mechanism that could have functions, operations, or configurations suitable for remote control. As such, the descriptions above are provided for exemplary purposes only and should not be regarded as limiting.

Various features of the invention are set forth in the following claims.

What is claimed is:

1. A controller for controlling at least one device of an apparatus, the device having a location in the apparatus, the controller comprising:
a housing having a shape resembling the apparatus; and
a switch coupled to the housing and located on the housing in a position corresponding to the location of the device on the apparatus, the switch operable to activate the device.

2. The controller of claim 1, wherein the controller comprises a remote key fob and the apparatus comprises a vehicle.

3. The controller of claim 1, wherein:
the apparatus includes at least two devices;
the controller includes at least two switches that independently control the at least two devices, respectively; and
the controller includes an additional switch to substantially simultaneously control the at least two devices.

4. The controller of claim 1, wherein the controller comprises a remote controller for remotely controlling the device, the controller further comprising a protrusion extending from the housing and receivable by the device for manual operation thereof.

5. The controller of claim 4, wherein the protrusion is movable between stowed and deployed positions with respect to the housing.

6. The controller of claim 1, wherein the device is operably movable with respect to the apparatus, and wherein the switch is movable with respect to the housing in a manner substantially mimicking the movement of the device with respect to the apparatus.

7. A fob for remotely operating a mechanism of a vehicle, the vehicle having a shape, the mechanism occupying an area of the vehicle, the fob comprising:
a body having a contour approximating the vehicle shape;
a switch coupled to the housing and operable to operate the mechanism of the vehicle, the switch positioned on the body at a location corresponding to the area occupied by the mechanism of the vehicle.

8. The fob of claim 7, wherein:
the vehicle includes at least two mechanisms; and
the fob includes at least two switches that independently control the at least two mechanisms, respectively.

9. The fob of claim 8, wherein the fob includes an additional switch that substantially simultaneously controls the at least two devices.

10. The fob of claim 9, wherein:
the mechanisms comprise automatic door locks; and
the additional switch is configured to substantially simultaneously lock the door locks.

11. The fob of claim 7, further comprising a key extending from the body and receivable by the mechanism for manual operation thereof.

12. The fob of claim 11, wherein the key is movable to and from a stowed position with respect to the housing.

13. The fob of claim 7, wherein:
the mechanism comprises a sliding door; and
the switch is operable to operate the sliding door and is slidable with respect to the body.

14. A remote control mechanism for remotely controlling an apparatus, the apparatus including components having locations on the apparatus and devices associated with the components, the devices operable to change the configuration of the components, the control mechanism comprising:
a housing shaped to resemble the apparatus;
switches coupled to the housing and operable to control the devices, at least one of the switches located on the housing at a position corresponding to the location of an associated component on the apparatus.

15. The remote control mechanism of claim 14, wherein the mechanism comprises a remote key fob, the apparatus comprises a vehicle, and at least one of the components comprises a vehicle door lock.

16. The remote control mechanism of claim 14, wherein at least two switches independently control at least two corresponding devices, the mechanism further comprising an additional switch that substantially simultaneously controls the at least two devices.

17. The remote control mechanism of claim 14, further comprising a protrusion extending from the housing and receivable by at least one of the devices for manual operation thereof.

18. The remote control mechanism of claim 17, wherein the protrusion is at least partially stowable in the housing.

19. The remote control mechanism of claim 14, wherein:
at least one of the devices is operable to move an associated one of the components with respect to the apparatus; and
at least one switch is movable with respect to the housing in a manner similar to the movement of the component with respect to the apparatus.

20. A method for remotely changing the configuration of a vehicle component, the vehicle having a shape and the component having a location on the vehicle, the method comprising:
providing a remote controller having a contour that resembles the vehicle shape;
positioning a switch on the controller in a position that corresponds to the location of the component;
remotely coupling the switch to the component for operative communication therewith; and
operating the switch to change the configuration of the component.

21. A remote controller for controlling devices on an apparatus, the apparatus having a plurality of portions each having a spatial relationship with respect to the apparatus, each device having a location on at least one of the portions of the apparatus, the remote controller comprising:
a body having portions corresponding respectively to portions of the apparatus, each portion having a spatial relationship with respect to the body that is similar to the spatial relationship of a corresponding portion of the apparatus with respect to the apparatus;
a switch located on a first portion of the body, the switch operable to control a device on the apparatus located on a first portion of the apparatus corresponding to the first portion of the body.

22. The remote controller as claimed in claim 21, wherein:
the apparatus is a vehicle;
the plurality of portions of the apparatus include sides, a front, and a rear of the vehicle; and
the portions of the body include sides, a front, and a rear of the body.

23. The remote controller as claimed in claim 22, wherein the switch is located on a side of the body and is operable to control a door latch on the vehicle.

24. The remote controller as claimed in claim 21, wherein the body has a shape of a vehicle, and wherein the portions of the body are portions of the vehicle.

25. The remote controller as claimed in claim 24, wherein the shape of the body resembles the shape of the apparatus.

26. The remote controller as claimed in claim 21, wherein the body at least partially defines a housing of a fob for remotely controlling devices of a vehicle.

27. The remote controller as claimed in claim 21, further comprising a key blade coupled to and extending from the body, the key blade adapted for insertion into a keyhole of at least one of the devices on the vehicle.

28. A method for remotely controlling a device on an apparatus, the method comprising:
identifying a portion of an apparatus to be controlled, the portion of the apparatus to be controlled having a first spatial relationship with respect to other portions of the apparatus;
selecting a portion of a remote control from a plurality of portions of the remote control, the selected portion of the remote control having a second spatial relationship with respect to other portions of the remote control that is similar to the first spatial relationship;
operating a switch on the selected portion of the remote control;
transmitting at least one signal from the remote control to the apparatus responsive to operation of the switch;
receiving the at least one signal at the apparatus; and
activating a device associated with the portion of the apparatus.

29. The method as claimed in claim 28, wherein:
the portion of the apparatus is a vehicle door;
the first spatial relationship is defined by a position of a vehicle door with respect to a remainder of the vehicle; and
activating the device includes activating a door latch of the vehicle door.

30. The method as claimed in claim 28, wherein selecting a portion of the remote control includes identifying a portion of the remote control having a shape similar to a shape of the portion of the apparatus to be controlled.

31. The method as claimed in claim 28, wherein selecting a portion of the remote control includes identifying a portion of the remote control having a position on the remote control similar to a position of the portion of the apparatus.

32. The method as claimed in claim 28, wherein:
the remote control has a vehicle shape;
the apparatus is a vehicle; and
selecting a portion of the remote control includes selecting a portion of the vehicle corresponding to a portion of the vehicle to be controlled.

33. The method as claimed in claim 32, wherein the remote control has a shape similar to a shape of the vehicle.

34. The method as claimed in claim 28, further comprising inserting a blade of the remote control into a keyhole in the apparatus.
